(19) United States
(12) Patent Application Publication
(10) Pub. No.: US 2012/0089875 A1
(43) Pub. Date: Apr. 12, 2012

(54) MULTI-USER TEST FRAMEWORK

(75) Inventors: Andrew E. Faust, West Jordan, UT (US); Kyrie Lynn Goodhart, Taylorsville, UT (US); Michael E. Tabet, Salt Lake City, UT (US)

(73) Assignee: Microsoft Corporation, Redmond, WA (US)

(21) Appl. No.: 12/900,454

(22) Filed: Oct. 7, 2010

(51) Int. Cl. H04L 9/32; G06F 11/36; G06F 21/00

(52) U.S. Cl. 714/38.1; 726/19; 714/E11.207

(57) ABSTRACT

Two user sessions can run concurrently on the same computer. A module executed by a first user instantiates a session manager in a first user session. The session manager receives input identifying a second user and providing credentials for the second user. A backup is made of auto-run and logon registry keys. A control file is created that directs actions in the second user session. The second user's credentials are registered in the registry file. The first session continues to execute while the second user is automatically logged on based on the registry auto login keys. The session manager is notified that login of the second user is complete. The session manager rewrites the auto login keys to the first user keys stored in the backup. The second user is logged off. The first user is automatically reconnected based on the rewritten registry keys.

### BACKGROUND

At times it would be helpful to be able to have more than one user session running concurrently on the same computer. For example, automated testing of software in a multi-user scenario is difficult on a computer that only allows one interactive user session to execute at a time because multiple test harnesses can not execute concurrently. The traditional way of testing a product that allows multiple users to use the product at the same time is to log out one user and then log in as a different user and run the tests. This does not permit testing of multiple concurrent sessions.

### SUMMARY

Instantiation of two or more concurrent user sessions running the same program or different programs can be performed on a computer by using a mechanism that enables auto logon using stored credentials. Two or more user sessions can run at the same time on the same computer but only one user session will be interactive at any point in time. The programs running in the multiple concurrently-running user sessions can interact using a shared file space. Commands to be executed in one session can be issued by another session. Program code in one user session can be executed concurrently with program code in another user session without needing the computer on which the sessions are run to have the ability to run multiple interactive user sessions. At any point in time, only one user session is connected to the input/output devices (i.e., only one user session is interactive). Switching connection to the input/output devices between user sessions can be automated by using stored logon credentials and automatic logon.

For example, a main interactive user session can be initiated. The main interactive user session can store logon credentials for another user (e.g., a second user). The main user session can be disconnected from input/output devices, rendering the main user session no longer interactive, and triggering the logon process to re-run. The user whose logon credentials were stored (e.g., the second user) can be automatically logged on to a new interactive user session (e.g., a second user session), and program code can be executed in the new interactive user session. When the new interactive user session completes, the main user session is notified and the second user session can be logged off. The main user session can be reconnected to the input/output devices so that the main user session is once more the interactive user session. Communication between interactive and not interactive sessions can be implemented by writing to a shared directory. Because multiple communicating concurrent user sessions can execute, even on a computer whose operating system does not support multiple active concurrent interactive sessions, multiple test harnesses can be run, allowing testing of products that can be used by multiple users at the same time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a system 100 for implementing multiple concurrent user sessions on a computer in accordance with aspects of the subject matter disclosed herein;

FIG. 2 is a flow diagram of an example of a method 200 for implementing multiple concurrent user sessions on a computer in accordance with aspects of the subject matter disclosed herein;

FIG. 3 is another flow diagram of an example of a method 300 for implementing multiple concurrent user sessions on a computer in accordance with aspects of the subject matter disclosed herein; and

FIG. 4 is a block diagram of an example of a computing environment in accordance with aspects of the subject matter disclosed herein.

### DETAILED DESCRIPTION

### Overview

To understand why running multiple concurrent user sessions can be useful, consider the following: suppose a first user logs onto a computer and runs a program. Suppose a second user logs into the same computer and accesses the same program. The computer would then be running two copies of the same program concurrently. Running two copies of the same program is tricky because one session may interfere with the other session. Testing a product that permits multiple user sessions of the same program to run on the same computer at the same time is difficult on a computer whose operating system restricts the number of active concurrent interactive sessions. For example, finding out what happens when a user logs onto and logs off of a user session of the product being tested is difficult because the test framework that would be running in the main user session would be terminated when the main user session is logged off. If, however, a second instance of the test framework is running, the second instance of the test framework can determine if the logon/logoff operation completes successfully.

In accordance with aspects of the subject matter disclosed herein, two or more user sessions can run on the same computer at the same time, even if the operating system that the computer is running only supports running one interactive user session at a time. The computer can be a server computer or a non-server computer. For example, the computer can run a non-server version of the Microsoft® Windows® operating system that does not allow multiple active concurrent interactive user sessions. A module executed by a first user can instantiate a session manager in a first interactive user session. In the first user session, the session manager receives input identifying a second user and providing credentials for the second user.

A backup copy of information associated with user logon credentials and logon processes can be made. For example, Microsoft® Windows® operating systems typically store logon credentials and auto-run logon processes in the registry. The session manager can make a backup of the original machine registry keys associated with auto-run and logon for the first user. The session manager can make a backup of start menu items for the first user. The start menu provides a customizable nested list of programs for a user to launch, a list of most recently opened documents, a way to find files, get help, and provide access to the system settings. Access to folders including user documents and browser bookmarks might also be included. After backing up the original settings, the session manager can remove auto-start applications from the registry file and from the start menu for the second user session, preventing auto-launching of programs in the second user session. Alternatively, other mechanisms may be employed to store information associated with user logon and logon processes and to modify the launching of programs in the second user session.

A control file of commands can be created by the session manager that directs actions in the second user session. Auto-logon can be set to the settings associated with the second user. For example, the second user's credentials can be registered in the auto-logon registry keys of the registry file. Alternatively, another mechanism can be employed to set information associated with logging on the second user. The session controller executable can be registered in the run registry keys of the registry file. Alternatively, another mechanism can be employed to automatically (programmatically) initiate running of the session controller executable in the second user session. Output devices can be disconnected from the first user session while the first user session continues to execute. Disconnecting the first user session from the input/output devices renders the first user session not interactive. The second user can be automatically logged on based on the registry auto login keys or by an alternative mechanism in a non-Windows environment. The session initiated for the second user can be interactive because the first user session is no longer interactive. A session controller can launch in the second interactive user session, load the control file and notify the session manager that login of the second user is complete. Communication between sessions can be implemented by writing to a directory that is accessible by both sessions. The session manager can change the auto login information to that associated with the first user, previously stored in a backup file to prepare for allowing the original (first user session) to auto-login. The session controller can execute the commands in the control file. When execution of the commands in the control file is complete, the session controller can log off the second user and notify the session manager to restore the original login information. In response to such notification, the first user can be automatically reconnected to the output devices. In a Microsoft® Windows® operating system, this is based on the rewritten registry keys.

### Implementing Concurrent User Sessions on a Computer

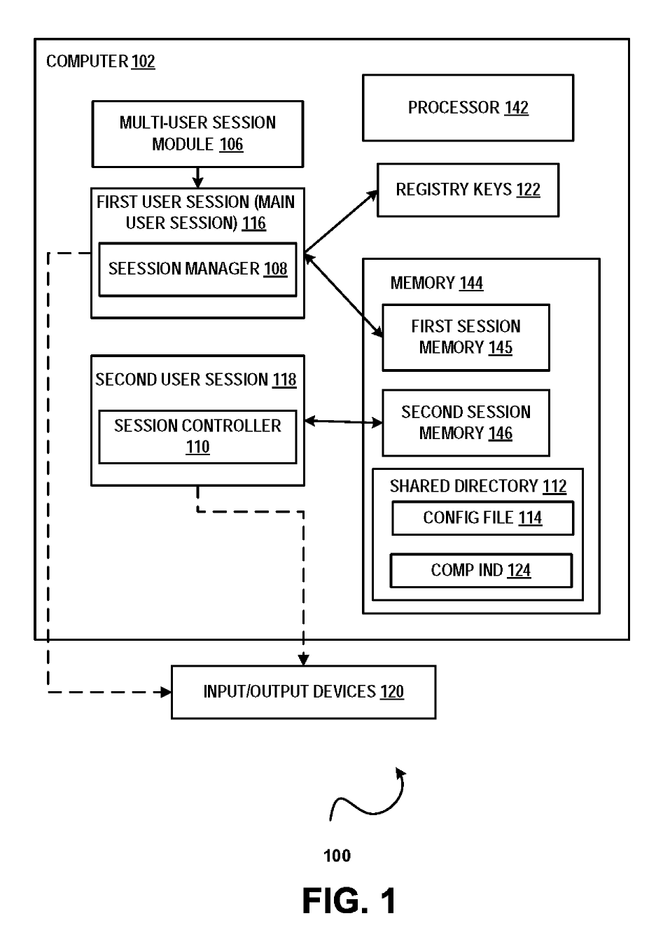

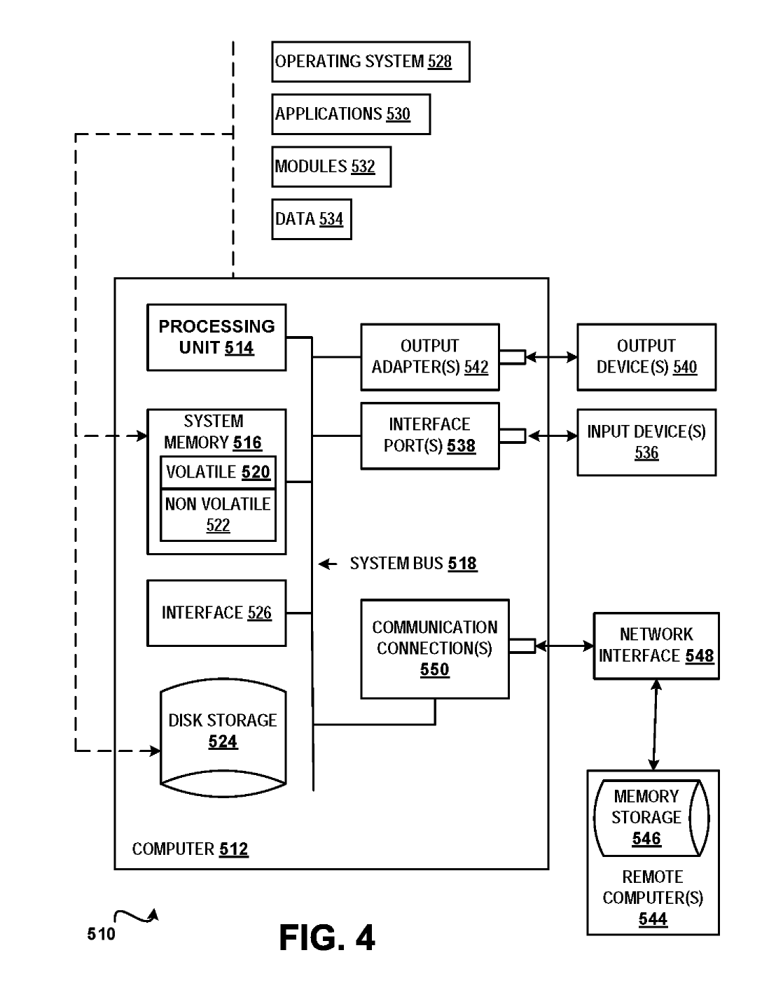

FIG. 1 illustrates an example of a system 100 in accordance with aspects of the subject matter disclosed herein. All or portions of system 100 can reside on a single computer. A computer is described below with respect to FIG. 4. System 100 or portions thereof may be provided as a stand-alone system or as a plug-in or add-in.

System 100 may include one or more of: a computer 102 or computing device. The computer 102 can be a server computer or a non-server computer. The computer 102 can be a computer that restricts the number of active concurrent interactive sessions. The computer 102 can run an operating system that limits the number of active concurrent interactive user sessions to one. For example, the computer 102 can run a non-server version of the Microsoft® Windows® operating system that does not allow multiple active concurrent interactive user sessions. The computer 102 can include a processor (such as processor 142), a memory such as memory 144, a module 106 implementing multiple concurrent active user sessions, a session manager 108, and/or a session controller 110 as described herein. System 100 might also include a shared directory 112. The shared directory 112 might include a configuration file 114, and/or a completion indicator file 124 and/or other files used to communicate between a first original or main user session (e.g., first user session 116) and another user session such as second user session (e.g., second user session 118). Other components well known in the arts may also be included but are not here shown. It will be appreciated that the module 106 implementing multiple concurrent active user sessions on a computer 102 can be loaded into memory 144 to cause one or more processors such as processor 142 to perform the actions attributed to the module 106 implementing multiple concurrent active sessions.

In accordance with aspects of the subject matter disclosed herein, a first user associated with main user session 116 can execute the module 106 implementing multiple concurrent active user sessions. It will be appreciated that although in the example provided, two user sessions are described, module 106 can instantiate two or more concurrent active user sessions on a computer. Main user session 116 can be assigned a portion of memory 144 for its memory (e.g., first session memory 145) that is separate from a portion of memory 144 assigned to a second user session 118, (e.g., second session memory 146). The module 106 implementing multiple concurrent active user sessions can call the session manager 108.

In some operating systems such as, for example, in Microsoft® Windows®, it is possible to set the operating system to automatically login a user by configuring certain operating system keys (e.g., winlogon registry keys). The registry keys can be set to specify a particular user to automatically log in, and can include credentials for the user including but not limited to the password for the user and so on. In other operating systems, other mechanisms may provide the same functionality. In accordance with some aspects of the subject matter disclosed herein, the first user has administrator privileges in order to have the permissions needed to be able to change registry keys including registry keys for auto-login. The session manager 108 can make a backup copy of the information that specifies programs that are automatically run upon login for the first user session. For example, the session manager 108 can make a backup copy of the auto-run registry keys for a computer that runs a Microsoft® Windows® operating system for the first user session. The session manager 108 can make a backup copy of the start menu items (or, for other operating systems, analogous information). The session manager 108 can remove auto-start applications from the registry and/or from the start menu for the first user session or otherwise prevent applications from automatically running upon user login. The session manager 108 can initialize a directory (e.g., shared directory 112) in memory 144 that will be used by both the first user session (main user session 116) and by another user session such as by a second user session (e.g., second user session 118) to communicate between the sessions.

The session manager 108 can set auto-login settings for the second user. For Microsoft® Windows® operating systems, the auto-login settings for the second user can be written to a registry file 122. Auto-login registry keys are needed for auto-login of the second user by a Microsoft® Windows® operating system. Alternatively, other mechanisms for storing auto-login settings for the second user can be employed for other operating systems. The session manager 108 can configure session controller 110 to implement auto-login. The session manager 108 can write a configuration file 114 for the session controller 110 in the shared directory 112. The configuration file 114 can be a file including but not limited to an XML file that provides commands that direct the session controller 110 (e.g., instructions that tell the session controller 110 what to execute). The session manager 108 can register the session controller executable in the run registry keys in the registry file 122. Alternatively, the session manager 108 can otherwise cause the session controller to execute when the second session begins. The session manager 108 can disconnect the main user session 116 (a first user session) from the output devices 120 (e.g., monitor, keyboard, mouse, etc.). Disconnecting the first user session can automatically trigger the operating system to re-run the login process and thus log in as the second user. In a Microsoft® Windows® operating system, this process is based on the auto-logon registry keys configured earlier. In accordance with some aspects of the subject matter disclosed herein, the output devices 120 are disconnected from the first user session by issuing an API call to a terminal services API to disconnect the current user session. In accordance with some aspects of the subject matter disclosed herein, the first user (e.g., the user associated with the main or first user session) can be returned to a secure login screen so that it appears that the first user logged off the first user's desktop.

The second user can be automatically be logged into an interactive user session by the operating system based on the registry settings (e.g., auto-logon registry keys) in a Microsoft® Windows® operating system. For example, the second user can be automatically logged in as directed by the winlogin registry keys in registry file 122 written previously by the session manager 108. The session control can signal the session manager 108 that login has completed, and the session manager 108 can restore the settings for the original session (e.g., the session manager 108 can rewrite the login keys to allow the original session to auto-login later). The session controller 110 may be automatically launched by the operating system due to the settings for the auto-run registry keys. Once activated, the session controller 110 can load and read the configuration file 114. The configuration file 114 tells the session controller 110 what to do (e.g., execute specified programs, test specified programs, etc.). The second user, in accordance with aspects of the subject matter disclosed herein, does not need administrator privileges because the first user session handles all actions requiring administrator privileges such as but not limited to writing the auto-logon registry keys. Thus, the second user does not have to have administrator privileges because the second user does not have to write to machine level settings (such as, for example, winlogon, run, etc.). However, the second user cannot run programs requiring administrator privileges unless the second user is an administrator. This can be advantageous, as for example, when a test harness is running Because typically a test harness runs as an administrator, any tests the harness executed would also have administrator permissions. Because the second user does not have to have administrator privileges, tests can be run as a non-administrator user.

When the session controller 110 has executed all the instructions specified in the configuration file 114 for the second interactive user session 118, the session controller 110 can log off the second user session 118 and the first user can be reconnected to its now interactive first user session automatically by the operating system. In a Microsoft® Windows® operating system, auto-login is based on the rewritten registry keys set by the session manager 108 after the second user login event was signaled by the session controller 110 and detected by the session manager 108. Output devices 120 can be re-connected to the first user session again, rendering it once more interactive. Any results returned from the second user session can be reported by the session manager 108 of the first user session. System 100 can be used in any product that interacts with multiple user desktops or anywhere code is executed by more than one user session. System 100 can be used for testing and UI Automation. UI Automation is an API for user interface (UI) accessibility that is designed to help Assistive Technology products interact with standard and custom UI elements of an application (or the operating system). UI Automation is also used to access, identify, and manipulate an application's UI elements. This feature can allow testing an application in the context of a user with restricted user permissions. Additionally, this solution can enable testing of scenarios requiring a user to logoff. This is typically difficult because logging off a user session would normally terminate the test harness. It will be appreciated that although two sessions are described herein, more than two user sessions can be run concurrently.

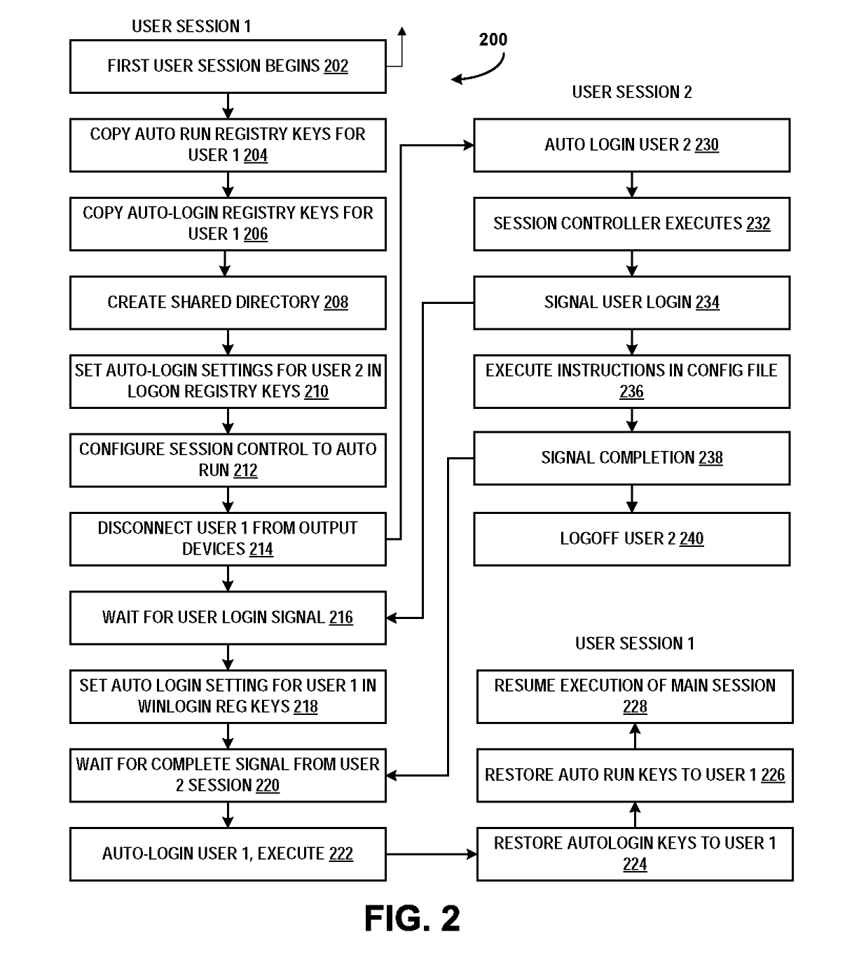

FIG. 2 illustrates an example of a method 200 for implementing multiple concurrent user sessions on a computer in accordance with aspects of the subject matter disclosed herein. The method described in FIG. 2 can be practiced by a system such as but not limited to the one described in FIG. 1. Some of the actions described below can be optional. Some of the actions described below can be executed in a sequence that differs from that described below.

At 202 a first (main or original) interactive user session can be instantiated. The first user session can be initiated by a user with administrator privileges even on a computer that does not support multiple concurrent interactive user sessions. It can also be initiated on a computer that does support multiple concurrent interactive user sessions. The first user session can execute a module that implements multiple user sessions on a computer. The module that implements multiple user sessions can call a session manager that makes a copy of the auto-run registry keys (204) and a copy of the auto-login registry keys (206). The session manager can initialize a directory (208) that will be shared by the first user session and a second user session. The session manager can specify the credential values for a second user and write them in an auto login registry key file (210). The session manager can configure a session controller to auto run (212). Input devices can be disconnected from the first user session (214) to trigger or initiate the auto login of a second user session (230). Disconnecting the input/output devices from the first user session renders it no longer interactive. At 216, the first user session, while still executing, waits for a user login signal signifying that the second user has been auto-logged in.

In response to auto login of the second user (230), the session controller described above starts to execute at 232 in the second user session. The session controller can signal that the second user has logged on by, for example, writing a logged-on file in the shared directory or by otherwise signaling the first user session that the second user session is executing (234). In response to detecting that the second user has logged in (e.g., by detecting the logged-on file in the shared directory), the auto-login registry keys can be set to the first user login values (218) in the first user session. At 220 the first user session waits for a signal from the second user session that execution of the second user session is complete.

At 236, in the second user session, the session controller can execute the instructions in the configuration file residing in the shared directory. For example, the instructions in the configuration file can execute a test using a test driver, store log files in the shared directory, and can repeat the process until all the instructions in the configuration file have been executed. Completion of execution in the second session can be signaled by writing a completion indicator in a file in the shared directory (238). At 240 the second user session can be logged off. At 222 in response to the first user session detecting the completion indicator written by the second user session (220), the first user session can be auto-logged in and can execute instructions such as but not limited to parsing test results, merging log results and so on. Programs in the first user session can execute concurrently with programs in the second user session. Programs that need the second user to finish and log off wait for the completion signal (220) before executing. At 224 the auto-login keys can be restored to those saved in the backup copy of the auto-login registry keys. At 226 the auto-run registry keys can be restored to those saved in the backup copy of the first user's auto-run registry keys and at 228 the execution of the first user session can continue.

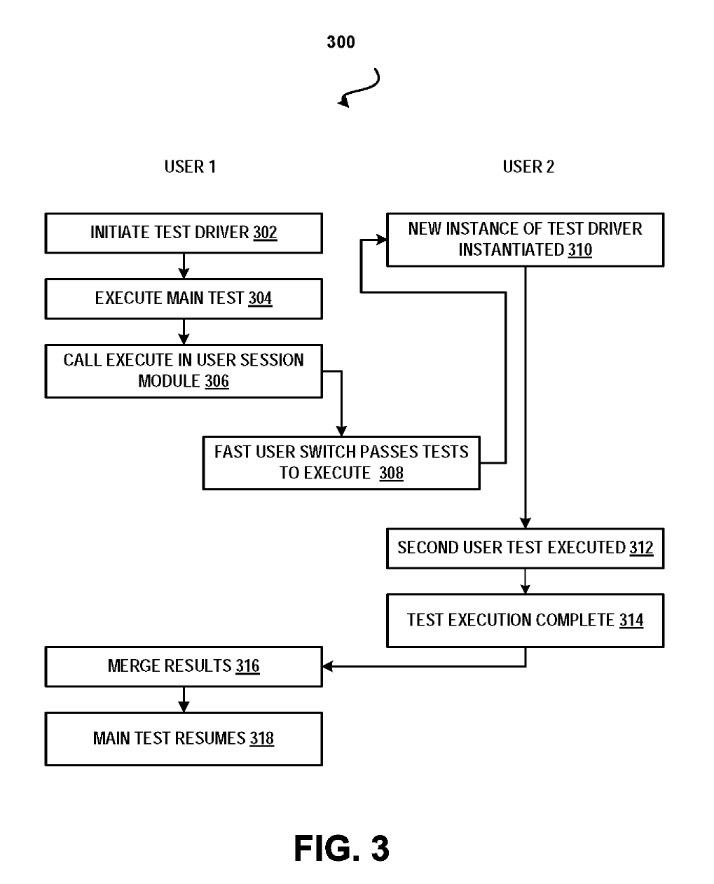

FIG. 3 is another flow diagram of an example of a method 300 for implementing multiple user sessions on a computer in a testing context in accordance with aspects of the subject matter disclosed herein. At 302 a first user (user 1) can execute an automated test by executing a test driver to run one or more tests. The test driver can be a host process that directs execution of one or more tests and reports test results. At 304 the main test can be executed. One possible example of a test is to switch to a second user, install a product, switch back to the first user and validate results. In such a scenario, the test can instantiate the session manager library directly referenced by the test. The session manager can be instantiated via test code that sets properties identifying the second user. The test can configure the session manager with the identity of the second user, the logon credentials for the second user, and can specify the code to execute in the second user session. At 306 the execute method can be called that performs the registry writes and the fast user switching to the second user (308) that passes the tests to execute in the second user session to the second user session. At 310 a new instance of the test driver can be instantiated in the second user session. At 312 the second user test(s) can be executed. When execution finishes (314), the first user can be auto-logged into the first user session. At 316 the test results for the first and second user sessions can be merged. At 318 the main test can be resumed in the first user session. This process can be used for automated testing of software that can be used by multiple users at the same time.

### Example of a Suitable Computing Environment

In order to provide context for various aspects of the subject matter disclosed herein, FIG. 4 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 4, a computing device in the form of a computer 512 is described. Computer 512 may include a processing unit 514, a system memory 516, and a system bus 518. The processing unit 514 can be any of various available processors. Dual microprocessors and other multiprocessor architectures also can be employed as the processing unit 514. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 4 describes software that can act as an intermediary between users and computer resources. This software may include an operating system 528 which can be stored on disk storage 524, and which can control and allocate resources of the computer system 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 4. Remote computer(s) 544 can be logically connected via communication connection 550. Network interface 548 encompasses communication networks such as local area networks (LANs) and wide area networks (WANs) but may also include other networks. Communication connection(s) 550 refers to the hardware/software employed to connect the network interface 548 to the bus 518. Connection 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways.

What is claimed:

1. A system comprising:
a processor and a memory of a computing device; and
a module on the computing device configured to cause the processor to initiate a first user session associated with a first user and a second user session associated with a second user on the computing device, wherein the first user session and the second user session execute concurrently on the computing device;
wherein launching the second user session is triggered by disconnecting input/output devices of the computing device from the first user session;
wherein logon credentials are set by the first user session for the second user session; and
wherein the first user session and the second user session communicate by writing to a directory shared by the first user session and the second user session.

2. The system of claim 1, wherein the first user session comprises a session manager that sets auto-login settings for the second user session and writes the auto-login settings for the second user session to a registry file used by an operating system to auto-login the second user.

3. The system of claim 1, wherein the first user session comprises a session manager that configures a session controller of the second user session to execute at least one command in the second user session.

4. The system of claim 1, wherein the first user session is disconnected from the input/output devices to signal an operating system of the computing device to auto-log in as the second user.

5. The system of claim 1, wherein the second user session is logged off in response to a signal indicating that execution of commands in a configuration file, the configuration file created by a session manager of the first user session, is complete.

6. The system of claim 1, wherein in response to the second user logging off, the first user is automatically logged in based on auto-login registry keys set by a session manager of the first user session.

7. The system of claim 1, wherein the first user session executes a first test harness and the second user session execute a second test harness for automated testing.

8. A method comprising:
instantiating a session manager in a first user session associated with a first user, the first user session executing on a computer;
making a backup copy of auto-run registry keys, auto-login registry keys and start menu items associated with the first user in the first user session;
creating a control file in the first user session, the control file comprising at least one command executed by a session controller in a second user session, the second user session associated with a second user, the second user session executing concurrently with the first user session on the computer;
registering credentials of the second user in a registry file on the computer, the registry file used by an operating system to auto-login the second user;
disconnecting output devices from the first user session;
rewriting auto-login registry keys in the registry file with the auto-login registry keys associated with the first user session stored in the backup copy in response to receiving a signal that login of the second user is complete;
instantiating the session controller in the second user session, wherein the session controller logs off the second user session in response to completion of execution of the at least one command in the control file; and
automatically logging in the first user based on the rewritten auto-login registry keys associated with the first user session.

9. The method of claim 8, further comprising:
instantiating the session manager via test code that sets properties identifying the second user.

10. The method of claim 8, wherein the first user session executes a test harness.

11. The method of claim 8, wherein the second user session executes a test harness.

12. The method of claim 8,
wherein auto-start applications are removed from the registry file and wherein auto-start applications are removed from a start menu in the first user session.

13. The method of claim 8, wherein the session controller of the second user session launches based on registry keys associated with the second user, the registry keys stored in the registry file.

14. The method of claim 8, wherein the session controller of the second user session signals the session manager of the first user session that login of the second user session has completed.

15. A computer-readable storage medium comprising computer-executable instructions which when executed cause at least one processor to:
instantiate a session manager in a first user session associated with a first user, the first user session executing on a computer;
make a backup copy of auto-run registry keys, auto-login registry keys and start menu items associated with the first user session;
create a control file in the first user session, the control file comprising at least one command executed by a session controller in a second user session, the second user session associated with a second user, the second user session executing concurrently with the first user session on the computer;
register credentials of the second user in a registry file on the computer, the registry file used by an operating system to auto-login the second user;
disconnect input/output devices of the computer from the first user session;
rewrite auto-login registry keys in the registry file with the auto-login registry keys associated with the first user session stored in the backup copy in response to receiving a signal that login of the second user is complete;
instantiate the session controller in the second user session, wherein the session controller logs off the second user session in response to completion of execution of the at least one command in the control file; and
automatically log in the first user based on the rewritten auto-login registry keys associated with the first user session.

16. The computer-readable storage medium of claim 15, comprising further computer-executable instructions, which when executed cause the at least one processor to:
instantiate the session manager via test code that sets properties identifying the second user.

17. The computer-readable storage medium of claim 15, comprising further computer-executable instructions, which when executed cause the at least one processor to:
executes a first test harness in the first user session concurrently with a second test harness in a second user session for automated testing of software, wherein the software is used by multiple users concurrently.

18. The computer-readable storage medium of claim 17, comprising further computer-executable instructions, which when executed cause the at least one processor to:
run the first test harness as an administrator and run the second test harness as a non-administrator user.

19. The computer-readable storage medium of claim 15, comprising further computer-executable instructions, which when executed cause the at least one processor to:
signal the session manager of the first user session that login of the second user session has completed.

20. The computer-readable storage medium of claim 15, comprising further computer-executable instructions, which when executed cause the at least one processor to:
launch the session controller of the second user session based on the second user registry keys in the registry file.
